(19) United States
(12) Patent Application Publication
(10) Pub. No.: US 2021/0056291 A1
(43) Pub. Date: Feb. 25, 2021

(54) METHOD FOR ANALYSIS OF AN INTRINSIC FACIAL FEATURE OF A FACE

(71) Applicant: Idemia Identity & Security France, Courbevoie (FR)

(72) Inventors: Julien DOUBLET, Courbevoie (FR); Jean BEAUDET, Courbevoie (FR); Maxime THIEBAUT, Courbevoie (FR)

(21) Appl. No.: 16/990,223

(22) Filed: Aug. 11, 2020

(30) Foreign Application Priority Data
Aug. 21, 2019 (FR) 1909321

(51) Int. Cl. G06K 9/00; G06K 9/52; G06K 9/62

(52) U.S. Cl. CPC G06K 9/00281; G06K 9/00288; G06K 9/6269; G06K 9/52

(57) ABSTRACT

A method for analysis of an intrinsic facial feature of a face presented (2) in a field of acquisition of an imager (3) comprising the following steps:
the imager (3) acquires a first image of a face, and then acquires a second image of the face,
based on the first image and the second image, a processing unit determines a variation of an intrinsic facial feature between the first image and the second image, without determining a value quantifying an absolute state of the intrinsic facial feature in the first image and/or in the second image;
based on the variation of the intrinsic facial feature, the processing unit determines a state of the face presented (2) in the field of acquisition of an imager (3) and performs an action depending on the state of the face presented.

### TECHNOLOGICAL BACKGROUND

The present invention belongs to the field of biometrics and more specifically covers the use of a variation of an intrinsic facial feature appearing in at least two images of a face for determining a state of the face presented in the field of acquisition of an imager.

In particular, the method can aim to implement a method for monitoring a driver, by which it is determined whether the driver of a vehicle is paying attention to the road. In case of a lack of attention (which could be combined with other conditions), the system can warn the driver, for example with a light or sound signal. Other actions can be taken, such as, for example, emergency braking if a hazardous situation is detected without the driver paying attention to the road. Such a method for monitoring a driver is based on analysis of the face of the driver for detecting signs of lack of attention (like for example looking away from the direction of the road) and therefore requires a reliable and precise analysis of the face.

The method can in particular be a biometric authentication method involving fraud detection. Some methods for identification or verification of identity call for acquiring an image of the face of the individual wishing to make use of an identity. For example, it can involve biometric identification methods based on analysis of elements of the face in order to reach an identification. Also, it can involve comparing the face of the person with photographs identifying them, notably during submission of identity documents such as a passport. Finally, access control methods based on facial recognition have recently appeared, in particular for unlocking a smart phone, like in U.S. Pat. No. 9,477,829.

Hence, the implementation of these methods requires protecting against fraud consisting of presenting the imager acquiring the image a reproduction of the face, such as a photograph. For this purpose, methods have been developed for authenticating the face, meaning for detecting possible fraud. Most of these methods are based on analysis of a required movement, which is generally called a challenge. Thus, the individual whose face is presented to the imager is asked to carry out precise actions such as blinking the eyes, smiling or nodding the head. However, such methods were found to be vulnerable to fraud based on presenting videos in which a face carries out the requested challenge.

The patent application US 2017/0124385 A1 describes a method for authentication of a user based on a challenge, meaning that the user must carry out a sequence of required movements. More precisely, the system asks the user to hold a relaxed position facing the camera, in which it acquires a first signature of the face, and then asks the user to turn to acquire a second signature of the face. Authentication is done by comparing the signatures in order to detect an inconsistency representative of fraud. The robustness of such an approach against fraud is not however perfect.

The biometric methods using the face require absolutely quantifying an intrinsic facial feature extracted from one image and comparing the value obtained with an expected value. However, absolute quantification of an intrinsic facial feature can be difficult and imprecise. For example, the method may comprise determining an exact pose of the face in an image. A pose of the face corresponds to the orientation thereof. As shown in FIG. 1, the orientation of the face can be described by three angles representing rotations about axes defined by the shared configuration of the faces. In fact, a face comprises a bottom (towards the neck), a top (the forehead/hair), a front where the mouth and eyes are fully visible and two sides where the ears are located. The various elements making up a face are distributed according to geometric criteria visible in a front view: the mouth is below the nose, the eyes are on a single horizontal line, the ears are also on a single horizontal line, the eyebrows are above the eyes, etc.

FIG. 1 shows a typical example of referencing the orientation of a face according to three angles around three orthogonal axes: a yaw angle around a vertical axis 20, a pitch angle around a first horizontal axis 21, and a roll angle around a second horizontal axis 22. Referring to faces, corresponding English terminology is used: “yaw” for the angle de lacet, pitch for the “angle d′assiette” or of “tangage” and “roll” for the “angle de gite.” Rotation around the vertical axis 20 corresponds to a rotation of the head from left to right, and inversely. The first horizontal axis 21 corresponds to a horizontal axis around which the head turns when nodding and can roughly be defined by the line connecting the two ears of the face. The second horizontal axis 22 corresponds to a horizontal axis comprised in a plane of symmetry of the face, intersecting the nose and the mouth and separating the eyes. The rotation around this second horizontal axis 22 corresponds to a tilting of the head to the left or the right.

Many methods have been proposed for determining the absolute pose of a face. The absolute pose can be determined from an image of the face by a recognition developed from deep learning (see for example the thesis “Head Pose Estimation using Deep Learning” by Ines Sophia Rieger, of Bamberg University), or determined from characteristic points defined on the face (see for example the article “Head Pose Estimation Based on Detecting Intrinsic facial features” by Hiyam Hatem et al., International Journal of Multimedia and Ubiquitous Engineering, Vol. 10, No. 3 (2015), pp. 311-322). Statistical approaches based on the symmetry of the face (for example the article “Head Pose Estimation Based on Face Symmetry Analysis” by Afifa Dahmane et al. Signal, Image and Video Processing, Springer Verlag, 2015, 9 (8), pp. 1871-1880) have also been proposed as have earlier approaches based on approaches of correlation of characteristics making it possible to get an approximation of the absolute pose.

However, it can be difficult to determine an absolute pose of the face from an image. The absolute pose of the face corresponds to a description (by the values of the roll, pitch and yaw angles) of the orientation of the face appearing in the image relative to a reference pose corresponding to a front view. However, human faces have a large variety of shapes, which can lead to determining erroneous poses. In particular, face asymmetries can result in errors. For example, the nose of one person can be more or less bent, which will lead to determining an erroneous pose because the nose is an essential element in the determination of the absolute pose of the face. Furthermore, lighting conditions can alter the determination of a correct absolute pose. The result of this is that the determination of the absolute pose of the face is imprecise or affected by error. Movements of the head are limited in amplitude, in particular to not lead to discomfort of the user by demanding they make overly large movements which could even be impossible for some people to do. The ranges of variation of pose angles are therefore generally limited from ±10° to ±20° relative to a front view, considered as reference pose. Hence, an uncertainty in the pose angles of a few degrees becomes problematic. The result of this is a large tolerance for challenges based on absolute poses of the face, thus reducing the reliability of fraud detection.

The situation is similar as it relates to absolute quantification of other intrinsic facial features from an image. For example, it can be difficult to quantify the opening state of an eyelid. In particular, the presence or absence of an epicanthic fold or more simply the variability of the shape of the eyes can lead to erroneous results. Thus, an open eye could be considered as half open, and vice versa.

Other approaches are based on the optical features of the images, independently from any direct relationship with any intrinsic facial feature of the face, thereby avoiding any problem related to quantifying such an intrinsic facial feature. For example, some approaches are based on an optical flow analysis. For instance, the article “A Liveness Detection Method for face Recognition Based on Optical Flow Field” by Wei Bao et al., International Conference on Image Analysis and Signal Processing, 2009, IASP 2009, IEEE, 11 Apr. 2009, describes using the optical flow analysis for authenticating a face, i.e. for spoofing detection, and in that case discriminate a living face from a photograph. The optical flow is the instaneous speed of a moving spatial object's pixel movement on the projection plane. The instantaneous change rate of intensity on specific point in projection plane is defined as optical flow vector. Optical flow field means apparent movement of image intensity pattern, which is a two-dimensional vector field. It contains information of instantaneous velocity vector of each pixel, and pixel's velocity vector can be seen as the corresponding point in spatial object mapping to projection plane. The optical flow analysis lies on analyzing vectors representative of intensity variations in the image, and therefore processes the image on the sole basis of the optical variations within it, regardless of any feature specific to a face appearing in the image.

The optical flow approach expresses the detected variations in terms of intensity and pixel numbers, and does not allow identifying variations of an intrinsic facial feature as such, as a variation of a physical quantity describing the absolute state of said intrinsic facial feature. Such variations are specific to the way a face moves, and cannot be summed up in a vector built from one pixel, even when taking into account the adjacent pixels. Intensity displacement from one pixel to another pixel cannot inform on the variation of a physical quantity describing the absolute state of an intrinsic facial feature, as for example indicating the angular change of the face pose or of the gaze pose, or the variation in the opening of an eyelid. On the contrary, a slight movement of the camera with respect to the face will induce a shift of every optical flow vectors, without any variation of an intrinsic facial feature such as a variation of the pose of the face, and/or a variation of a pose of at least one eye, and/or a variation of opening of at least one eyelid, and/or a shape variation of the mouth and/or a shape variation of an eyebrow.

### BRIEF DESCRIPTION OF THE INVENTION

An object of the invention is to remedy these disadvantages at least in part and preferably all of them, and the invention aims in particular to propose a method for analysis of the face presented to a terminal allowing the tracking of an intrinsic facial feature with which to implement a driver monitoring or fraud detection method in the context of a biometric identification method which is at the same time simple, robust and has an improved reliability compared to methods based on an absolute quantification of an intrinsic facial feature of the face.

For this purpose, a method for analysis of a face presented in a field of acquisition of an imager is proposed, said face comprising an intrinsic facial feature with an absolute state which could be voluntarily modified by an individual presenting their face, and related to said face without any acquired image, the method comprising the following steps:
the imager acquires a first image of a face presented in the field of acquisition thereof, and then the imager acquires a second image of the face presented in the field of acquisition thereof, with an intrinsic facial feature of the face presented appearing in the first image and in the second image;
based on the first image and the second image, a processing unit determines a variation of the intrinsic facial feature between the first image and the second image, the variation of the intrinsic facial feature being expressed as a variation of a physical quantity describing the absolute state of said intrinsic facial feature, without determining a value of the physical quantity quantifying said absolute state of the intrinsic facial feature in the first image and/or in the second image;
based on the variation of the intrinsic facial feature, the processing unit determines a state of the face presented in the field of acquisition of an imager and performs an action depending on the state of the face presented.

The method is advantageously supplemented by the following characteristics, taken alone or in any of their technically possible combinations:
the variation of the intrinsic facial feature corresponds to a variation of the three-dimensional geometry of the face presented;
the variation of the intrinsic facial feature is a rotation, and/or a deformation, and/or a movement of the intrinsic facial feature between the first image and the second image;
the variation of the intrinsic facial feature is a variation of the pose of the face, and/or a variation of a pose of at least one eye, and/or a variation of opening of at least one eyelid, and/or a shape variation of a mouth of the face and/or a shape variation of an eyebrow;
the variation of the intrinsic facial feature is a variation of the pose of the face defined by a variation of an angle representative of the orientation of the face, and in which the at least one angle representative of the orientation of the face is a yaw angle around a vertical axis, and/or a pitch angle around a first horizontal axis, and/or a roll angle around a second horizontal axis
the method comprises a step of detection of the face in each of the first image and the second image prior to the determination of the variation of the intrinsic facial feature between the first image and the second image, where said step of detection of the face comprises the determination of a region of interest in an image corresponding to the localization of the face in said image, the variation of the intrinsic facial feature between the first image and the second image being determined from a first region of interest in the first image and a second region of interest in the second image;
the variation of the intrinsic facial feature between the first image and the second image gets a calculation model involved that takes as input the first image and the second image or regions of interest thereof, or a difference between the first image and the second image or regions of interest thereof, where the output of the calculation model is at least one rotation and/or one difference of a value representative of the variation of the intrinsic facial feature;
the calculation model is a neural network, a support-vector machine or a decision tree;
the calculation model is configured during a supervised learning phase using a database having faces presenting various states of the intrinsic facial feature in which the values quantifying the states of the intrinsic facial features have been recorded, where the image data are augmented by image degradation and/or positioning defects for the region of interest;
the first image and the second image belong to a sequence of images acquired by the imager, and the processing unit implements a tracking of the absolute state of the intrinsic facial feature based on images from the acquired sequence by using a recursive filter combining information on the absolute state of the intrinsic facial feature in an image from the sequence of images and a variation of the intrinsic facial feature between successive images from the sequence of images;
the state of the face presented is a state of attention, and in which the action done by the processing unit is an implementation of a method for monitoring a driver;
the state of the face presented is an authenticity or not of the face presented, and the action done by the processing unit is an implementation of a fraud detection method based on the variation of the intrinsic facial feature between the first image and the second image, where the processing unit authenticates or not the face presented in the field of acquisition of the imager depending on the result of the fraud detection method;
the fraud detection method uses a challenge, and the authentication is based on the comparison between both the variation of the intrinsic facial feature between the first image and the second image and also on a variation of the intrinsic facial feature expected in response to the challenge;
the variation of the intrinsic facial feature is a pose variation of the face, and the fraud detection method uses a technique of structure acquired from a movement, SfM, and the authentication is based on the three-dimensional geometry of the face shown, where the implementation of the SfM technique is conditioned on the fact that the pose variation of the face between the first image and the second image is greater than a threshold.

The invention also relates to a computer program product comprising program code instructions recorded on a non-volatile medium usable in a computer for execution of the steps of a method according to the invention when said program is executed on a computer using said non-volatile medium.

The invention finally relates to a terminal comprising an imager and a processing unit, where said terminal is configured for implementing a method according to the invention.

### DESCRIPTION OF THE FIGURES

The invention will be better understood through the description below, which relates to embodiments and variants according to the present invention, given as non-limiting examples and explained with reference to the attached schematic drawings, in which:

FIG. 1 shows schematically the angles defining the pose of a face;

FIG. 2 shows schematically a person presenting their face to a terminal during implementation of the method according to a possible embodiment of the invention;

FIG. 3 shows a block diagram of steps implemented in the authentication method, according to a possible embodiment of the invention.

### DETAILED DESCRIPTION

The invention relates to a method for analysis of the face involving the determination of a variation of an intrinsic facial feature between two images and to be used in various applications. In particular, the invention can target implementing a monitoring method for a driver, or implementing fraud detection in connection with biometric authentication. In all cases, a variation of an intrinsic facial feature appearing in at least two images of a face is used for determining a state of the face presented in the field of acquisition of an imager. For reasons of simplicity and for illustration and without limitation, the invention will be presented below in the context of a biometric authentication method for a face, but the teaching can be used for any application involving analysis of a face. In this context, the state of the face presented is an authenticity or not of the face presented, and the action done by the processing unit is an implementation of a fraud detection method based on the variation of the intrinsic facial feature between the first image and the second image.

The biometric authentication method for a face presented to an imager implements a method for fraud detection based on the variation of an intrinsic facial feature between two images. The intrinsic facial feature corresponds to a face trait, which could vary over a short time (typically less than five seconds), preferably under control of the person showing their face. The variation of the intrinsic facial feature can for example be a variation of the pose of the face, and/or a variation of the pose of an eye, and/or a variation of opening of at least one eyelid, and/or a shape variation of a mouth of a face and/or a shape variation of an eyebrow, or a combination thereof. Because of this, the person presenting their face can voluntarily move their head to change the pose of their face, close or open eyelids, or follow an object with their eyes. Typically, the variation of the intrinsic facial feature corresponds to a variation of the three-dimensional geometry of the face presented. More specifically, the variation of the intrinsic facial feature is a rotation, and/or a deformation, and/or a movement of the intrinsic facial feature between the first image and the second image.

On the other hand, intrinsic facial features such as the width of the forehead, the color of the skin or the separation of the eyes, are not intrinsic facial features considered for the fraud detection method since such intrinsic features does not have an absolute state which could be voluntarily modified by an individual presenting their face. Furthermore, the intrinsic facial feature is an intrinsic feature of the face presented, meaning that it is relative to the face presented and not to just the representation of this face in the acquired image. Thus, the characteristics of image sharpness or luminosity, related to the conditions of acquisition or the adjustments of the imager, are not intrinsic characteristics of the face presented. An intrinsic facial feature exists independently of any image acquisition.

For purposes of illustration without limitation, a variation of the pose of the face, defined as above by at least one angle variation (rotation or angle difference) representative of the orientation of the face, is used as a primary example of a variation of an intrinsic facial feature. The teachings related to the use of the variation of the pose of the face can easily be transposed by the person skilled in the art to the use of other variations of intrinsic facial features.

With reference to FIG. 2, the authentication method can be implemented by means of a terminal 1 to which a face 2 of a user is presented. The terminal 1 comprises a processing unit and an imager 3 suited for acquiring images of objects presented in the field of acquisition 4 thereof. Preferably, the terminal 1 also comprises a screen 5 capable of displaying images to the user and is configured such that the user can simultaneously present their face 2 in the field of acquisition 4 of the imager 3, and look at the screen 5. The terminal 1 can thus be, for example, a smart phone type pocket terminal, which typically has an adequate configuration between the imager 3 and the screen 5. The terminal 1 can just the same be any type of computer terminal, and it can in particular be a fixed terminal dedicated to identity controls, for example installed in an airport. The terminal 1 can also be an electronic device embedded in a vehicle forming a driver monitoring system. The processing unit comprises at least one processor and a memory, and with it a computer program can be executed for implementing the method.

The user presents their face 2 in the field of acquisition 4 of the imager 3. As any face, the presented face 2 comprises at least one intrinsic facial feature with an absolute state that could be voluntarily modified by an individual presenting their face, said intrinsic facial feature related to the said face even without any acquired image. The imager 3 acquires at least one first initial image of the face 2 (step S01). The imager next acquires (step S02) a second image of the face presented in the field of acquisition 4 thereof. The first image and the second image can be part of a sequence of images, for example making up a video acquired by the imager 3. The first image and the second image can be successive images in time from the sequence of images or can be images separated in time by intermediate images. The first image and the second image can also be images taken in isolation from each other. Typically, the analysis method is implemented on the sequence of images acquired, and the first image and the second image are continuously updated. Preferably, the first image from one iteration is the second image from the previous iteration.

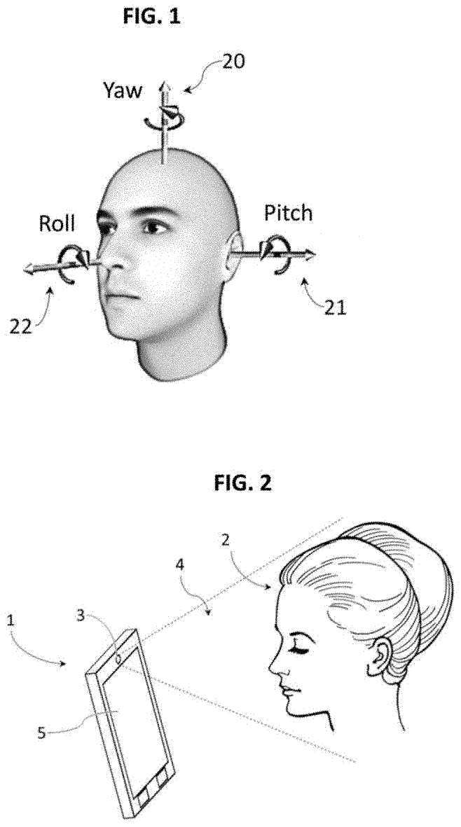

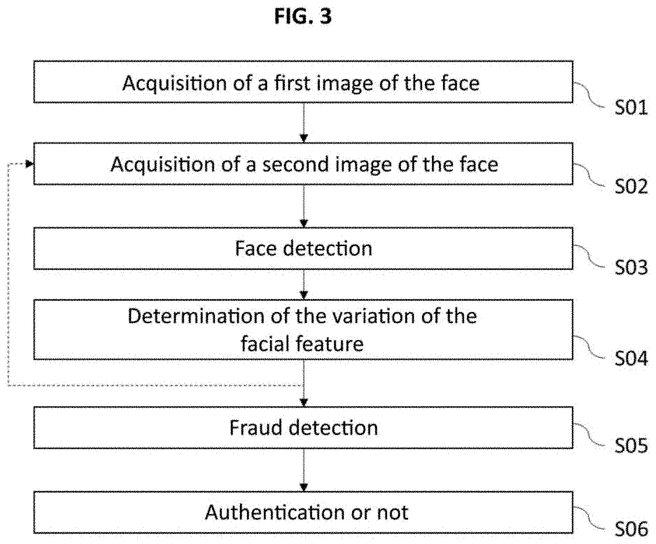

Since the acquisition of the first image and the acquisition of the second image are not simultaneous, an intrinsic facial feature of the face in the second image differs from the same intrinsic facial feature of the face in the first image, reflecting a change of the appearance of the face 2 presented to the imager 3. For example, by taking the pose of the face as an intrinsic facial feature, the face in the second image presents a different pose from the pose of the face in the first image, reflecting a movement of the face 2 presented. Referring to FIG. 1, the face can pivot around the vertical axis 20 modifying the yaw angle of the pose, and/or around the first horizontal axis 21 modifying the pitch angle of the pose. The variation of the intrinsic facial feature, for example due to the movement of the face, can be done by the person presenting their face 2 to the imager for the purpose of responding to a challenge involving doing required movements.

The method can next comprise a step of detection of the face (step S03) in each of the first image and the second image. The step of detection of the face comprises the determination of a region of interest in one image corresponding to the location of the face in said image. The region of interest is typically a rectangular zone (or box) encompassing the face in order to isolate the face from the environment thereof appearing in the background of the image. Other types of regions of interest can be used. The region of interest can for example be defined by a contour between the skin and the background, marking out the face relative to the background thereof.

The region of interest can be determined by means of several approaches. One approach is for example analyzing the image for detecting physical particularities therein such as the eyes. Insofar as the faces are made up of similar elements (e.g. eyes, noses, mouth, etc.) similarly spatially organized, detection of these elements is made easier. Another approach is to use for example a calculation model such as a neural network, a support-vector machine, or a decision tree, previously trained on a learning base of images having varied faces.

This step of detection of the face can be implemented by the processing unit on the first image and the second image sent by the imager 3. It is also possible that this step of detection of the face is implemented by an element other than the processing unit, like, for example, the imager 3, and that the processing unit only receives the regions of interest instead of the full images.

The processing unit then determines a variation of an intrinsic facial feature of the face between the first image and the second image (step S04). This determination of a variation of an intrinsic facial feature is not a simple detection of a movement in the images, but requires being able to identify the representation of the intrinsic facial feature in the images. The variation of the intrinsic facial feature is expressed as a variation of a physical quantity (angle, distance, etc.) describing the absolute state of said intrinsic facial feature. This variation is therefore not expressed in terms of pixels in the image, which are not physical quantities that can intrinsically describe a face without any acquired image. In the case of a pose variation, this pose variation is defined by at least one angle variation representative of the orientation of the face. As indicated above, this angle variation can for example be a rotation or an angle difference. The variation of the pose can be expressed by rotation angle values or angle differences. Typically, a variation of an intrinsic facial feature such as the pose of the face can be expressed according to angles relative to the axes of the face, and in particular as explained above by a yaw angle, pitch angle or roll angle difference. However it is possible (and easier) to use angles relative to the axes of the imager 3, because the processing is done on images acquired by the imager 3. For reasons of simplicity, the example here uses angle differences relative to axes of the face.

The processing unit can thus determine a yaw angle difference around the vertical axis 20 between the face from the first image and the face from the second image, and/or a pitch angle difference around a first horizontal axis 21 between the face from the first image and the face from the second image, and/or a roll angle difference about a second horizontal axis 22 between the face from the first image and the face from the second image. It is possible to determine the three angle differences, only two angle differences or else only one angle difference. For example, it is not always necessary to determine the roll angle. In fact, a variation of the roll angle corresponds to a leaning of the head to the left or to the right. Because of the small amplitude of rotation of the face in this direction, and the discomfort that this rotation can produce if the person has to do it, this roll angle difference can go unused. Thus, the angle difference is preferably a yaw angle difference or a pitch angle difference.

Of course, other variations of an intrinsic facial feature can be determined. It is for example possible to determine a variation of the gaze direction, which can be expressed as a pose of at least one eye, and therefore be determined in a way very similar to the variation of the pose of the face. It is also possible to determine a variation of opening of at least one eyelid. The variation of opening of an eyelid can for example be expressed by a modification of the width-to-height ratio of the space of an eye left open by the eyelid. The variation of a mouth shape can for example be expressed as the modification of the parameters of a polynomial (in the simplest case, a parabola) defining a separation curve between the two lips of the mouth. The same applies for the variation of an eyebrow shape, with the shape variation expressed by the parameters of a polynomial defining a median curve of the eyebrow. The variation of the shape of the mouth can also be expressed by the variation of opening thereof (for example for detecting a yawn), by using the same modalities as the variation of the opening of the eyelid.

The variations of several intrinsic facial features can correspond to variations of the three-dimensional geometry of the face. For example, it is possible to determine, from each of the two images, a three-dimensional model of the surface of the face, typically a point grid, and for example the model of 68 notable points of the face (68 Point Face Landmark Model). It is then possible to determine a variation (rotation or position difference) for the points of the grid.

The variation of the intrinsic facial feature between the first image and the second image is directly determined by the processing unit, meaning without quantifying the state of the intrinsic facial feature in the first image and/or quantifying the state of the intrinsic facial feature in the second image, meaning without determining a value quantifying an absolute state of the intrinsic facial feature. There is no determination of a value of a physical quantity (angle, distance, etc.) describing the absolute state of said intrinsic facial feature.

For example, the method does not determine an absolute pose of the face in the first image and/or an absolute pose of the face in the second image. An absolute pose of the face is defined by at least one angle representative of the orientation of the face relative to a reference related to the acquisition field (face referential or imager referential), typically from front. As explained above, it can be difficult to determine an absolute pose of the face, which results in imprecisions or errors in the absolute poses determined. By directly determining the pose variation of the face between the two images, the method therefore considers only the variation of this pose occurring between the two images. Now, the determination of the variation of a pose is more precise than the determination of an absolute pose.

For example, a bent nose could lead to errors in the determination of the absolute pose. Whereas the eyes seem in front, the bent nose can give the impression of a tilted head. The determination of the absolute pose can also vary between a forward or tilted pose, for example because of slight movements of the face or variations of the light which can get involved in the result of the determination. In the case of processing an image stream, an instability of the absolute pose determined can then result from it. On the other hand, the bent appearance of the nose does not affect the pose variation which can be deduced from the images. In fact, whatever the unusual appearance of the alignment of the nose and eyes, this alignment pivots with the movements of the head changing the pose of the face. The determination of the pose angle difference is therefore not affected by this bent nose.

It is the same for other intrinsic facial features. The determination of the gaze direction, and therefore the pose of the eyes, can be difficult. For example, a defect of parallelism of the visual axes of the eyes (strabismus) can interfere with the determination of the absolute pose of the eyes. Furthermore, problems such as anisocoria can make determination of the absolute pose of the eyes difficult. In contrast, the variation of the pose of the eyes when following an object is distinctly more reliable, despite for example the presence of the strabismus. Concerning the opening of the eyelids, it can be difficult to determine and use an absolute quantification of the opening of the eyelids such as the ratio of width over height because of the large diversity of the structure of eyelids (for example the presence or absence of epicanthic fold) or the shape of the eyes, it is instead more reliable to determine the variation of the opening of the eyelids.

The variation of the intrinsic facial feature between the first image and the second image is determined from the first image and the second image, in the form of complete images or of regions of interest of these images. In particular, when a step of detection of the face in each of the first image and the second image is implemented prior to the determination of the variation of the intrinsic facial feature, the variation of the intrinsic facial feature between the first image and the second image can be determined from a first region of interest in the first image and a second region of interest in the second image, the region of interest in an image corresponding to the location of the face in said image. Typically, the first image and the second image can be sent (directly or indirectly) by the imager 3 to the processing unit. It is also possible that the processing unit may receive only regions of interest from each of the images.

In order to determine the variation of the intrinsic facial feature between the first image and the second image, the processing unit can use a calculation model that takes as input the first image and the second image or regions of interest thereof. It is also possible that the calculation model take as input a difference between the first image and the second image or a difference between regions of interest thereof. The output of the calculation model is at least one rotation or one value representative of the variation of the intrinsic facial feature. For example, in the case of the variation of the pose of the face, it can involve an angle difference representative of the orientation of a face, which defines the pose difference of the face between the first image and the second image. Preferably, the output of the calculation model is at least two angle differences, and more precisely a yaw angle difference and a pitch angle difference.

Typically, the calculation model is a neural network, a support-vector machine or a decision tree, resulting from an automatic learning process. The calculation model can in particular be configured during a supervised learning phase using a database of images presenting faces with various states of the intrinsic facial features (for example several different poses of the face). In the database of images, the values quantifying the states of the intrinsic facial features (for example various absolute poses expressed by values of angles) of faces from the database of images are populated. Thus, a value quantifying an absolute state of the intrinsic facial feature, for example an absolute pose expressed in terms of angles relative to a reference frame is associated with each face from an image in the database. These states of the intrinsic facial features can for example be determined by the methods indicated above. In the database, a single face is presented on at least two images, with different states of the intrinsic facial features, and these two images are presented as input to the calculation model according to the modalities of the subsequent use thereof (for example presentation or not in the form of regions of interest only). The outputs from the calculation model take the form of quantity of variation of the intrinsic facial feature (for example pose angle differences) and are compared with the quantities of variation between the absolute states (for example differences between absolute poses) associated with images of the same face in the database. In order to improve the robustness of the calculation model, it is possible to augment the image data with image deteriorations and/or defects in positioning of the region of interest. Because of the augmentation of the data during learning, the calculation model works better under real conditions, when acquired images have defects.

Depending on the modalities of the acquisition of the images, the determination of the variation of the intrinsic facial feature can be done iteratively. It is then possible to only modify one image between the first image and the second image of the face between two iterations. Typically, only the second image is changed during each of several iterations. Thus, in the case of image acquisition in the form of a video stream, a first image constituting a reference can remain unchanged for several determinations of variations of the intrinsic facial feature, whereas the second image is continuously changed to account for the development of the intrinsic facial feature of the face in the video stream. The advantage of this approach is to reduce the image processing because it [is] then not necessary to redo processing such as detection of the face each time for the first image. Furthermore, by keeping a single image for several iterations, it is possible to show greater changes of the intrinsic facial feature which can for example exceed a predetermined threshold, triggering the performance of a specific action. Preferably however, the two images are kept relatively close timewise (for example 1 second difference at most) such that a single image is only retained for a limited number of iterations.

Inversely, using two images close in time and always renewed results in the detection of all changes of the intrinsic facial features by only covering a comparison time limited to the time interval between the two images, which can be short. To detect a large change of the intrinsic facial feature, extending over several images, it is then necessary to integrate the values quantifying the variations of the intrinsic facial feature determined on each iteration, like for example the angle differences when the intrinsic facial feature is the pose of the face.

When the variation of the intrinsic facial feature has been determined, or more typically when a plurality of variations of the intrinsic facial feature have been determined, the processing unit determines a state of the face presented 2 in the field of acquisition of an imager 3 and performs an action depending on the state of the face presented. A state of the face presented can be a variable feature of the face such as an expression of the face showing an emotion or attention (view directed towards the road, eyes open, etc.) or an intrinsic feature of the face, like for example the authentic appearance thereof or not. In the context of the example of a biometric authentication method, the state of the face presented is an authenticity or not of the face presented, and the action done by the processing unit is an implementation of a fraud detection method based on the variation of the intrinsic facial feature between the first image and the second image. The processing unit therefore implements a fraud detection method (step S05) based on the variation of the intrinsic facial feature between the first image and the second image. The processing unit authenticates or not (step S06) the face presented 2 in the field of acquisition of the imager 3 depending on the result of the fraud detection method.

The fraud detection method can implement a challenge. For that purpose, the person who presents their face 2 in the acquisition field of the imager 3 can receive an instruction, typically by a message displaying on the screen 5, asking them to change as instructed the intrinsic facial feature on their face whose variation is used.

For example, when the variation of the intrinsic facial feature is a pose variation of the face, the screen 5 can display a displayed image comprising at least one visual reference for orientation whose position depends on the pose of the face, and a visual target in a target position, where the person has to change the pose of their face to move the visual reference to the target position. The first image and the second image are acquired to observe the modification of the pose of the face that the person does for performing the instruction.

The authentication can then be based on the comparison between on the one hand the of the intrinsic facial feature of the face between the first image and the second image and on the other hand a variation of the intrinsic facial feature expected in response to the challenge. If the variation of the intrinsic facial feature of the face between the first image and the second image corresponds sufficiently to expected variation of the intrinsic facial feature, the face 2 presented in the field of acquisition of the imager 3 is then considered authentic. Conversely, if the variation of the intrinsic facial feature of the face between the first image and the second image differs too much from the expected variation of the intrinsic facial feature, the face 2 presented in the field of acquisition of the imager 3 is considered as a fraud. In fact, it probably involves a fraud based on the presentation of a video in which a face does not present a variation of the intrinsic facial feature corresponding to the proposed challenge.

The fraud detection method can use a technique of structure acquired from a movement, or SfM for “Structure from Motion”, and the authentication is based on the three-dimensional geometry of the face presented. With such a technique, frauds based on the presentation of videos or photographs in which the face is seen as flat can be detected. If the technique of structure acquired from a movement shows a face found to be flat, the face 2 presented in the field of acquisition of the imager 3 is considered a fraud. Otherwise, the face is considered to be authentic. The implementation of the technique of structure acquired from movement can be conditioned on the fact that the pose variation of the face between the first image and the second image is greater than a threshold. This threshold can for example be a difference of 5° to 10° for at least one of the angles defining the pose of the face.

It is in fact too costly, in terms of calculation resources and/or calculation time to use this technique on all images acquired by the imager 3, even though only pairs of images showing sufficiently different face poses serve to implement this technique effectively. The determination of the pose variation of the face between the first image and the second image according to the method described above makes it possible to determine whether the pose variation of the face is sufficient for using the technique of structure acquired from movement in a much less costly way. Thus, the structure acquired from a movement technique is only used for pairs of images which will give an effective result.

As brought up above, the teachings mentioned in the context of a biometric authentication method are transposable to other applications. Thus, the state of the face presented can be a state of attention of the driver, and the action done by the processing unit can be an implementation of a method for monitoring a driver.

As discussed above, the processing unit determines a variation of the intrinsic facial feature between the first image and the second image, without determining a value quantifying an absolute state of the intrinsic facial feature in the first image and/or in the second image. However, it is possible, in parallel with the determination of the variation of the intrinsic facial feature (relative determination), to determine an absolute state of the intrinsic facial feature in an image (preferably other than the first image and the second image). By determining an absolute state of the intrinsic facial feature, a starting point for tracking the intrinsic facial feature is available. The variations of the intrinsic facial feature, determined as explained above, are used for updating the absolute state of the intrinsic facial feature, iteratively by using the first image and the second images acquired over time. In this way, the state of the intrinsic facial feature can be tracked without temporal noise which would be inherent in an absolute image by image estimate of the absolute state of the intrinsic facial feature.

Typically, by having a sequence of acquired images to which the first image and the second image belong, the processing unit can implement a tracking of the absolute state of the intrinsic facial feature based on images from the acquired sequence by using a recursive filter combining information on the absolute state of the intrinsic facial feature of an image from the sequence of images and a variation of the intrinsic facial feature between successive images from the sequence of images. In fact, relative and absolute information about the intrinsic facial feature in the sequence of acquired images can be combined using a recursive filter such as a Kalman filter. Thus, information about the absolute state of the intrinsic facial feature for that image (“position information”) can be associated with each image (or only for images a given number of images apart, i.e. each k^{th} image), and a variation of the intrinsic facial feature relative to the preceding image (“speed information”) can be associated with each image.

An initial image from the sequence of acquired images can be used for determining an initial state of the intrinsic facial feature, and then the following images are used for determining the variation of this intrinsic facial feature, and the state of the intrinsic facial feature is changed by means of the variation determined, by using a recursive filter (for example a discrete Kalman filter), where the variation of the intrinsic facial feature between the first image and the second image is used for updating the state of the intrinsic facial feature.

The invention is not limited to the embodiment described and depicted in the attached figures. Modifications remain possible, particularly from the viewpoint of creating various technical characteristics or substituting technical equivalents, without departing from the scope of protection of the invention. In particular, other fraud detection methods can be implemented, as long as they make use of the variation of an intrinsic facial feature between two images.

1. A method for analysis of an intrinsic facial feature of a face presented in a field of acquisition of an imager, said face comprising an intrinsic facial feature with an absolute state which could be voluntarily modified by an individual presenting their face, and related to said face without any acquired image, the method comprising the following steps:
the imager acquires a first image of a face presented in the field of acquisition thereof, then the imager acquires a second image of the face presented in the field of acquisition thereof, with the intrinsic facial feature of the face presented appearing in the first image and in the second image;
based on the first image and the second image, a processing unit determines a variation of the intrinsic facial feature between the first image and the second image, the variation of the intrinsic facial feature being expressed as a variation of a physical quantity describing the absolute state of said intrinsic facial feature, without determining a value of the physical quantity quantifying said absolute state of the intrinsic facial feature in the first image and/or in the second image;
based on the variation of the intrinsic facial feature, the processing unit determines a state of the face presented in the field of acquisition of an imager and performs an action depending on the state of the face presented.

2. The method according to claim 1, wherein the variation of the intrinsic facial feature corresponds to a variation of the three-dimensional geometry of the face presented.

3. The method according to claim 1, wherein the variation of the intrinsic facial feature is a rotation, and/or a deformation, and/or a movement of the intrinsic facial feature between the first image and the second image.

4. The method according to claim 1, wherein the variation of the intrinsic facial feature is:
a variation of the pose of the face, and/or
a variation of a pose of at least one eye, and/or
a variation of opening of at least one eyelid, and/or
a shape variation of the mouth and/or a shape variation of an eyebrow.

5. The method according to claim 1, wherein the variation of the intrinsic facial feature is a variation of the pose of the face defined by a variation of an angle representative of the orientation of the face, and wherein the at least one angle representative of the orientation of the face is a yaw angle around a vertical axis, and/or a pitch angle around a first horizontal axis, and/or a roll angle around a second horizontal axis.

6. The method according to claim 1, comprising a step of detection of the face in each of the first image and the second image prior to the determination of the variation of the intrinsic facial feature between the first image and the second image, where said step of detection of the face comprises the determination of a region of interest in an image corresponding to the localization of the face in said image, the variation of the intrinsic facial feature between the first image and the second image being determined from a first region of interest in the first image and a second region of interest in the second image.

7. The method according to claim 1, wherein the variation of the intrinsic facial feature between the first image and the second image involves a calculation model that takes as input the first image and the second image or regions of interest thereof, or a difference between the first image and the second image or regions of interest thereof, where the output of the calculation model is at least one rotation and/or one difference of a value representative of the variation of the intrinsic facial feature.

8. The method according to claim 7, wherein the calculation model is a neural network, a support-vector machine or a decision tree.

9. The method according to claim 7, wherein the calculation model is configured during a supervised learning phase using a database of images having faces having various states of the intrinsic facial feature, the values quantifying the states of the intrinsic facial feature being recorded, the image data being augmented by image degradation and/or positioning defects of the region of interest.

10. The method according to claim 1, wherein the first image and the second image belong to a sequence of images acquired by the imager, and the processing unit implements a tracking of the absolute state of the intrinsic facial feature based on images from the acquired sequence by using a recursive filter combining information on the absolute state of the intrinsic facial feature in an image from the sequence of images and a variation of the intrinsic facial feature between successive images from the sequence of images.

11. The method according to claim 1, wherein the state of the face presented is a state of attention, and in which the action done by the processing unit is an implementation of a method for monitoring a driver.

12. The method according to claim 1, wherein the method is a biometric authentication method, and the state of the face presented is an authenticity or not of the face presented, and the action done by the processing unit is an implementation of a fraud detection method based on the variation of the intrinsic facial feature between the first image and the second image, where the processing unit authenticates or not the face presented in the field of acquisition of the imager depending on the result of the fraud detection method.

13. The method according to claim 12, wherein the fraud detection method uses a challenge, and the authentication is based on the comparison between on the one hand the variation of the intrinsic facial feature between the first image and the second image and on the other hand a variation of the intrinsic facial feature expected in response to the challenge.

14. The method according to claim 12, wherein the variation of the intrinsic facial feature is a pose variation of the face, and the fraud detection method implements a technique of structure acquired from a movement, SfM, and the authentication is based on the three-dimensional geometry of the face shown, where the implementation of the SfM technique is conditioned on the fact that the pose variation of the face between the first image and the second image is greater than a threshold.

15. A non-transitory computer-readable medium with program code instructions recorded thereon for execution of the steps of a method according to claim 1 when said non-transitory computer-readable medium is read by a computer.

16. A terminal comprising an imager and a processing unit, where said terminal is configured for implementing a method according to claim 1.
